(19) United States
(12) Patent Application Publication
(10) Pub. No.: US 2020/0380842 A1
(43) Pub. Date: Dec. 3, 2020

(54) DEPENDENT MONITORING AND CAREGIVING SYSTEM

(71) Applicant: ANTS TECHNOLOGY (HK) LIMITED, HONG KONG (HK)

(72) Inventors: Ron Fridental, Shoham (IL); Ori Tal, Tel Aviv (IL); Masha Zeldin-Melamed, Ramat-Gan (IL); Oranit Dror, Rishon LeZion (IL); Idit Diamant, Raanana (IL)

(21) Appl. No.: 16/775,288

(22) Filed: Jan. 29, 2020

Related U.S. Application Data
(60) Provisional application No. 62/853,227, filed on May 28, 2019.

(51) Int. Cl. G08B 21/04; G06K 9/00

(52) U.S. Cl. CPC G08B 21/0476; G06K 9/00771; G08B 21/0423

(57) ABSTRACT

A system for dependent monitoring and caregiving, the system comprising: an image sensor for capturing image data of a scene in which a dependent is situated; a controller configured to control various modules in the environment of the dependent; and a processor configured to tun a decision module configured to detect a state of the dependent based on image data and to execute code instructions for: receiving image data from the image sensor; analyzing the received image data by the decision module and detect a state of the dependent based on the analysis; instruct the controller to control various modules in the environment of the dependent in response to the detected state; and generate and output a report about the dependent state.

### BACKGROUND

There are some known baby monitoring systems using sound and image detectors. Most of these monitoring systems provide image and/or sound data to a parent or another caregiver that needs to interpret the sound and; or image by themselves. This may cause many false alarms and thus anxiety, restlessness and sleep deprivation for both the caregiver and the infant. Additionally, in some cases, it takes a caregiver too much time to act in response to a situation shown by the monitoring system, longer than an optimal response time. Additionally, existing systems don't enable a caregiver to notice health and/or development abnormalities in the infant in an optimal time for treatment.

### SUMMARY

An aspect of some embodiments of the present disclosure provides a system for dependent monitoring and caregiving, the system comprising: an image sensor for capturing image data of a scene in which a dependent is situated; a controller configured to control various modules in the environment of the dependent; and a processor configured to run a decision module configured to detect a state of the dependent based on image data and to execute code instructions for; receiving image data from the image sensor; analyzing the received image data by the decision module and detect a state of the dependent based on the analysis; instruct the controller to control various modules in the environment of the dependent in response to the detected state; and generate and output a report about the dependent state.

Optionally, the processor is configured to execute instructions for detecting based on received image data when the dependent's face is absent from the captured image data.

Optionally, the processor is configured to execute instructions for detecting based on received image data a situation causing the absence of the face from the image data.

Optionally, the processor is configured to execute instructions for instructing the controller to perform actions to check or fix the detected situation of the dependent.

Optionally, the processor is configured to execute instructions for detecting whether a being is crossing bounds of a defined area in the scene.

Optionally, the processor is configured to execute instructions for detecting whether the crossing being is the dependent or an authorized being.

Optionally, the processor is configured to execute instructions for transmitting an alert in case a being entering the defined area is not authorized, or in case the dependent exits a defined area.

Optionally, the processor is configured to execute instructions for detecting whether dependent is discontent.

Optionally, the processor is configured to execute instructions for instructing the controller to perform calming actions in the dependent's environment.

Optionally, the processor is configured to execute instructions for using image data as feedback to actions of the controller, by detecting the dependent's reactions to the actions.

Optionally, the processor is configured to execute instructions for instructing, the controller according to the feedback.

Optionally, the processor is configured to execute instructions for detecting along time abnormal behavior or development of the dependent by analyzing image data of at least a few hours.

### BRIEF DESCRIPTION OF THE DRAWINGS

Some non-limiting exemplary embodiments or features of the disclosed subject matter are illustrated in the following drawings.

In the drawings:

FIG. 1 is a schematic illustration of a system for dependent monitoring and caregiving, according to some embodiments of the present disclosure;

FIG. 2 is a schematic flowchart illustrating a method of dependent monitoring and caregiving, according to some embodiments of the present disclosure;

FIG. 3 is a schematic flowchart illustrating a method for detection of the dependent's face in a scene, according to some embodiments of the present disclosure;

FIG. 4 is a schematic illustration of a method for fencing monitoring, e.g. detection of crossing of a bound into and/or out of an area in the scene, according to some embodiments of the present disclosure;

FIG. 5 is a schematic illustration of a method for dependent discontentment detection, according to some embodiments of the present disclosure; and

FIG. 6 is a schematic illustration of a method for detection of abnormal dependent development, according to some embodiments of the present disclosure.

With specific reference now to the drawings in detail, it is stressed that the particulars shown are by way of example and for purposes of illustrative discussion of embodiments of the disclosure, In this regard, the description taken with the drawings makes apparent to those skilled in the art how embodiments of the disclosure may be practiced,

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described. References to previously presented elements are implied without necessarily further citing the drawing or description in which they appear.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

### DETAILED DESCRIPTION

Before explaining at least one embodiment of the disclosure in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

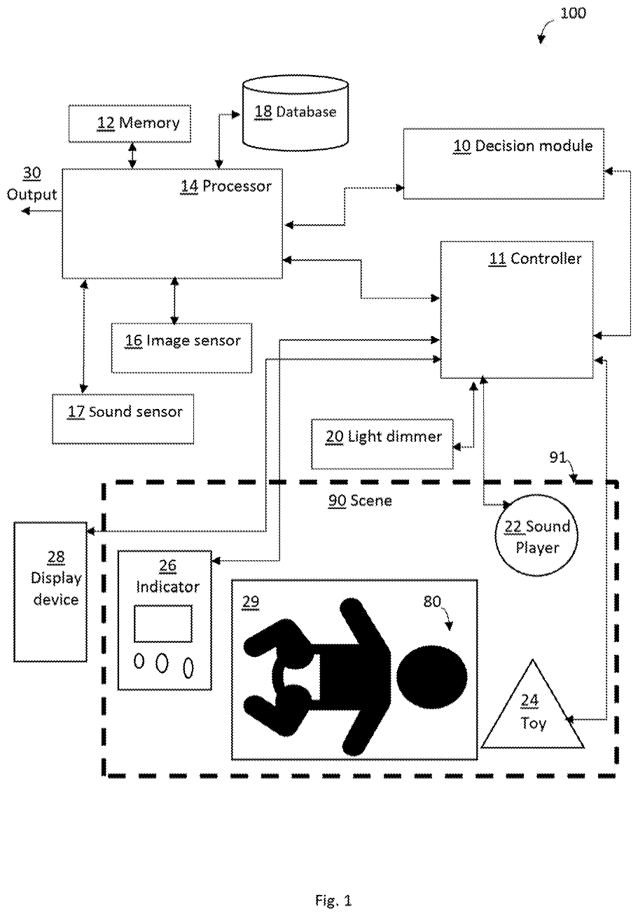

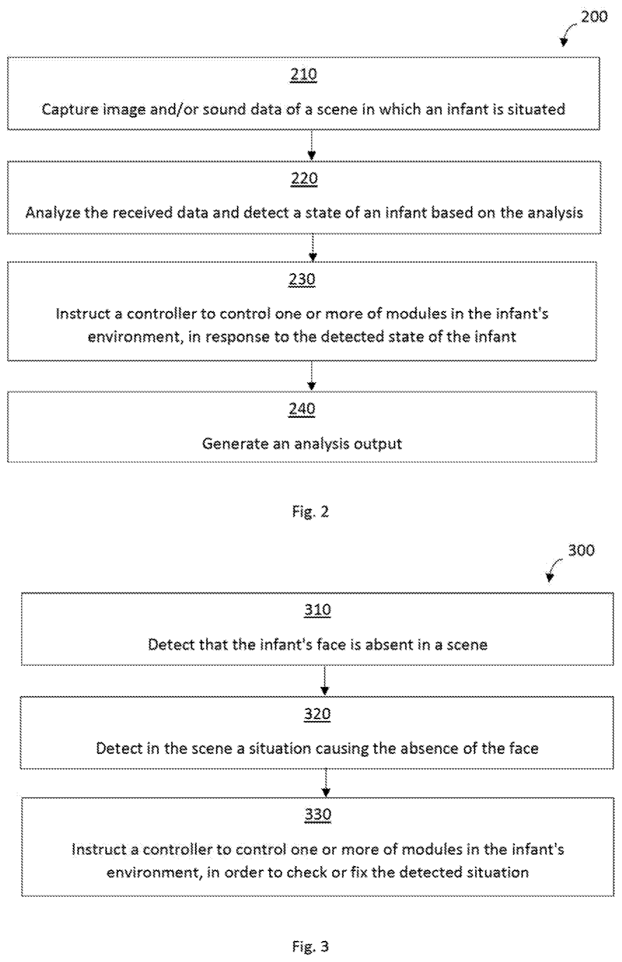

Reference is now made to FIG. 1. which is a schematic illustration of a system 100 for dependent monitoring and caregiving, according to some embodiments of the present disclosure. Further reference is made to FIG. 2, which is a schematic flowchart illustrating a method 200 of dependent monitoring and caregiving, according to some embodiments of the present disclosure. System 100 may monitor and/or provide care for a dependent/infant 80 situated in a scene 90. Dependent/infant 80 may be an infant, a toddler, an elder person, a pet, an, animal, and/or any other suitable dependent being, i.e. a being that depends on the treatment and/or care of another person for its well-being. Throughout the present description, the terms “infant” and “dependent” are used interchangeably. It will be appreciated that some embodiments of the present invention may be used for any other suitable dependent as well as for an infant.

System 100 may include at least one decision module 10, at least one controller 11, at least one hardware storage medium 12, at least one hardware processor 14, at least one image sensor 16, optionally a sound sensor 17, and a database 18, Processor 14 may include, control and or communicate with decision module 10, controller 11. storage medium P, image sensor 16, and/or database 18, for example to execute method 200 according to instructions stored in storage medium 12. For example, storage medium 12 is a non-transitory memory storing code instructions executable by processor 14. When executed, the code instructions cause processor 14 to carry out the steps of method 200 as described in detail herein. Processor 14 may execute, run and/or control a decision module 10, According to some embodiments of the present disclosure, decision module 10 is configured to classify data and/or to detect certain states, and/or any other suitable target task. In some embodiments, decision module 10 is configured to be trained to perform and/or enhance performance of the classifying, detecting, and/or another suitable task. For example, decision module 10 includes machine learning and/or artificial intelligence capabilities, such as artificial neural networks.

In some embodiments of the present disclosure, system 100 may include a plurality of modules, for example, at least some of them in the environment of dependent 80, For example, system 100 may include a light dimmer 20, a sound player 22, a toy 24 (for example, a mobile), a state indicator 26 and a display device 28.

In some embodiments of the present disclosure, decision module 10 may be configured to analyze a received dataset of image and/or sound of a monitored scene 90 in which an infant 80 is situated, detect a state of infant 80 in monitored scene 90, and execute and/or generate instructions based on the analysis. For example, as described in more detail herein, based on a detected state of infant 80, decision module 10 may execute an instruction to store data in database 18, to send data to processor 14, and/or may generate and/or transmit an instruction to controller 11. For example, controller 11 controls at least one of a plurality of modules 20-28 in the environment of infant 80 based on instructions received from processor 14 and/or decision module 10, as described in more detail herein below.

As indicated in block 210, image sensor 16 may capture image data of scene 90 and send the captured data to decision module 10. In some embodiments, sound sensor 17 may detect sound data from scene 90, for example concurrently with the capturing by image sensor 16, and may send the sound data to decision module 10, for example with relation to the captured image data, such as a time stamp that may enable relation between the image data and the sound data. The image data and/or sound data may be stored in database 18, for example, with relation between the image and sound data.

Decision module 10 may receive the image data and/or sound data. For example, decision module 10 may receive a dataset of image data and/or sound data, and/or synchronized image and sound data. As indicated in block 220, decision nodule 10 may analyze the received data and detect a state of infant 80 based on the analysis. Decision module 10 may perform an action based on the detected state of infant 80, as described in more detail herein below. For example, as indicated in block 230, decision module 10 may instruct controller 11 to control one or more of modules 20-28, in response to the detected state of infant 80, As indicated in block 240, processor 14 may generate an analysis output 30, for example including a detected state, a report about changes in the state along time, a recommendation for an action by the caregiver, or any other suitable output and/or may display and/or voice the generated output and/or send it to another device, For example, decision module 10 may detect based on the image and/or sound datasets various health conditions such as irregular and/or abnormal breathing, heartbeat rate, skin conditions, and/or any other suitable conditions, In response to detection of an irregular and/or abnormal health condition, module 10 and/or controller 14 may generate and/or transmit an alert as output 30 and/or instruct controller 11 to indicate the condition, for example by indicator 26.

According to some embodiments of the present disclosure, decision module 10 is configured to detect, based on the received image data and/or sound data, when the infant is in a dangerous state. For example, decision module 10 is configured to detect when the face of infant 80 are covered with a blanket or otherwise not detected in the scene.

In some embodiments of the present invention, decision module 10 may be trained, based on data accumulated by the image and/or sound sensors and/or based on a pre-accumulated dataset, to recognize a bed and/or a toy and/or another object in the infant's environment and to analyze and/or detect whether the object is safe, for example according to known standard parameters and/or any other suitable criteria. For example, decision module 10 may detect whether a bed's length is sufficient, whether the bed barrier's height is safe to prevent the infant's falling and/or climbing over the barrier, whether the distance between the gratings is proper, etc. For example, decision module 10 may detect if a too small object and/or an exposed string or wire is located in the infant's environment For example, decision module 10 may detect hazardous events, for example if the infant puts a small object in its mouth, puts its head between the bed's gratings, bends over the bed's barrier, etc.

According to some embodiments of the present invention, based on the received image and/or sound data, decision module 10 may be configured and/or trained to automatically detect an area where the infant is situated, and focus and/or move the image and/or sound sensors to capture data from a restricted area, and/or apply a mask to obtain, use and/or store only data capture from a certain detected area that is recognized by module 10 as the infant's environment. This may be used, for example, in order to keep privacy of other residents of a certain room.

According to some embodiments of the present invention, decision module 10 may be configured to distinguish between several kinds of the infant vocals, such as between several kinds of crying sounds, and to provide an indication about the infant's needs accordingly.

According to some embodiments of the present invention, based on the received image and/or sound data, decision module 10 may be configured and/or trained to automatically detect and/or recognize alarm sounds of various detectors located in proximity to the infant, such as smoke and/or motion detectors, and to activate an alert accordingly.

Reference is now made to FIG. 3 which is a schematic flowchart illustrating a method 300 for detection of the infant's face in scene 90, according to some embodiments of the present disclosure. As indicated in block 310, decision module 10 may detect, for example based on a received image dataset, that the infant's face is absent in scene 90. For example, decision module 10 may be configured to detect when an infant's face is in the scene. in other embodiments, decision module 10 may be configured to detect face of a specific infant or specific group of infants. For example, processor 14 may receive an image of a specific infant and train decision module 10 to detect the face of the specific infant, Then, in case the face of the infant is absent from the received image data, decision module may detect that the infant's face is not in the scene. As indicated in block 320, decision module 10 may also detect in the scene a situation causing the absence of the face from the image data, and/or a state of tine infant. For example, module 10 may detect if the infant's face is covered by a blanket, the infant's face is directed away from the image sen scar, and/or any other suitable situation. Further, decision module 10 may sense vital signs of the infant, for example the infant breathing and/or heartrate states, for example based on sound and/or image data received from sensors 16 and 17. In some embodiments, decision module 10 may analyze an image and/or sound dataset, and detect based on the image dataset an event or a series of events causing the absence of the infant's face from the monitored scene. For example, decision module 10 may detect that the infant roiled on their stomach, that the infant covered their face with a blanket, and/or any other suitable process. Decision module 10 may send information about the detected state and/or cause to processor 14. Processor 14 may output the information as output 30, for example to inform a caregiver. As indicated in block 330, decision module 10 and/or processor 14 may generate and/or transmit an instruction to controller 11 to perform actions in response to the detected state, for example in order to check and/or fix the detected situation of infant 90. For example, controller 11 may control sound player 22 to make sounds, and/or a toy 24 to move and/or make sounds, which may cause the infant to roll over, to turn their head or to remove a blanket from their face. For example, controller 11 may control state indicator 26 to provide information about the infant's state, For example, state indicator 26 may include a display, light indicators, sound indicators and/or any other suitable indicators to indicate about the infant's state.

According to some embodiments of the present disclosure, decision module 10 is configured to detect when infant 80 exits a certain defined area in scene 90. For example, a user may define a certain bound 91 in scene 90, and/or decision module 10 may be configured to detect when infant 80 exits and/or crosses the defined bound 91, for example, exits a certain area defined by the bound 91. In some embodiments, decision module 10 is configured to detect when another being, for example a person or an animal, crosses a defined bound 91 into an area in which the infant may be situated.

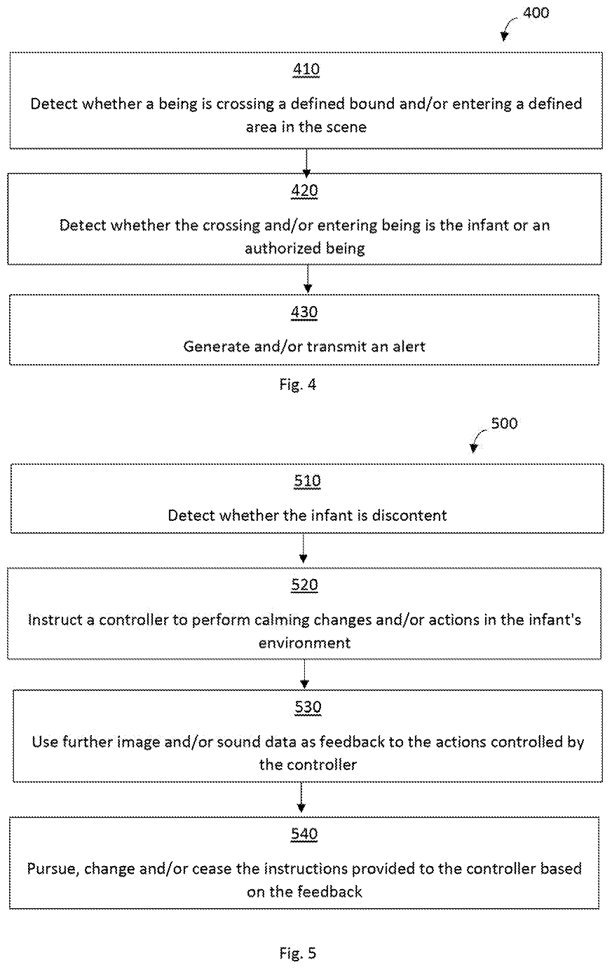

Reference is now made to FIG. 4, which is a schematic illustration of a method 400 for fencing monitoring, e.g. detection of crossing of a bound 91 into and/or out of an area in scene 90, according to some embodiments of the present disclosure. As indicated in block 410, decision module 10 may detect whether a being is crossing a defined bound 91 and or entering a defined area in scene 90, For example, module 10 may be configured to detect whether the being is infant 80, the infant's parent or caregiver or another authorized being. For example, processor 14 may receive a definition of an authorized being and/or an image of the authorized being, and/or may train decision module 10 to detect whether a being in the monitored scene is infant 80 or an authorized being. Accordingly, as indicated in block 420, decision module 10 may detect whether the crossing and/or entering being is infant 80 or an authorized being, As indicated in block 430, in case a being is entering the defined area is not authorized, or in case infant 80 exits a defined area, decision module 10 and/or processor 14 may generate and/or transmit an alert, for example as output 30 and/or by state indicator 26. In case the being entering the area is an authorized being, decision module 10 and/or processor 14 may generate an indication and/or about, for example, an event of entering the area by the authorized being, for example with indication about the identity of the entering being.

According to some embodiments of the present disclosure, decision module 10 is configured to detect when infant 80 in uncomfortable, irritated, or discontent. For example, based on image and/or sound datasets and/or based on the infant's movements, facial expressions and/or vocals.

Reference is now made to FIG. 5, which is a schematic illustration of a method 500 for infant discontentment detection, according to some embodiments of the present disclosure. As indicated in block 510, decision module 10 may detect whether infant 80 is discontent, irritated, uncomfortable and/or displeased. For example, module 10 may be configured to detect based on certain body, head, and/or limbs motions that the infant is uncomfortable. For example, module 10 may detect based on certain facial expressions and/or movements of infant 80 that the infant is in pain and/or irritated and/or otherwise uncomfortable. Module 10 and/or processor 14 may generate an indication about the infant's discontent and/or provide the indication as output 30, for example to a caregiver. As indicated in block 520, module 10 and/or processor 14 may generate and/or transmit instructions to controller 11 to perform calming changes and/or actions in the infant's environment, for example by modules 2026 and/or any other suitable modules. For example, based on the instructions, controller 11 may control light dimmer 20 to adjust light intensity, control sounds generator 22 to output soothing, sounds, such as light music, white noise, sea sounds, wind sounds, animal sounds, control display device 28 to display a face of a familiar person and/or a calming image and/or video, control inclination of a surface 29 on which the infant is placed to make the infant more comfortable, and/or any other suitable calming changes and/or actions. As indicated in block 530, module 10 may receive further image and/or sound data from sensors 16 and 17, and/or use the further image and/or sound data as feedback to the actions controlled by controller 11. As indicated in block 540, module 10 may pursue, change and/or cease the instructions provided to controller 11 based on, detected changes in the infant's behavior, movements, expressions and/or vocals, based on which module 10 may detect that the actions of controller 11 have positive, negative, or no effect on the infant. For example, in case module 10 detects that the actions don't calm the infant in a sufficient manner, for example if the expressions, movements and/or vocals indicating discomfort are not reduced below a certain threshold, module 10 and/or processor 14 may change the instructions to controller 11 to perform other soothing actions until the desired calming result is reached, e.g. if the expressions, movements and/or vocals indicating discomfort are reduced below a certain threshold.

In some embodiments of the present disclosure, analyzed image and/or sound datasets, i.e. image and/or sound datasets with relation to results of the analysis by module 10, indications, alerts and/or events, may be stored in database 18. In some embodiments, database 18 may be shared in a data cloud with other systems 100. In some embodiments, the analyzed datasets may be used to further train decision module 18 to obtain better results, e.g. more accurate detection of states.

In some embodiments of the present disclosure, processor 14 and/or decision module 10 may generate a report based on a series of along with corresponding analysis results, events, indications and/image and/or sound datasets or alerts. For example, decision module 10 may analyze long term image and/or sound datasets, for example along several hours, days, weeks or months, and detect a certain condition based on the analysis. For example, processor 14 may receive certain criterions of normal infant development, such as normal reactions to various kinds of stimulation, facial expressions, loughs, vocal abilities, and/or any other suitable expressions, Decision module 10 may be trained to detect abnormal infant development along time for example based on gathered image and/or sound datasets and detection of the infant's reactions, facial expressions and/or vocals, which may be stored in database 18, for example along with corresponding time stamps. in case decision module 10 detects abnormal development of the infant, an indication may be provided as output 30 and/or by indicator 26.

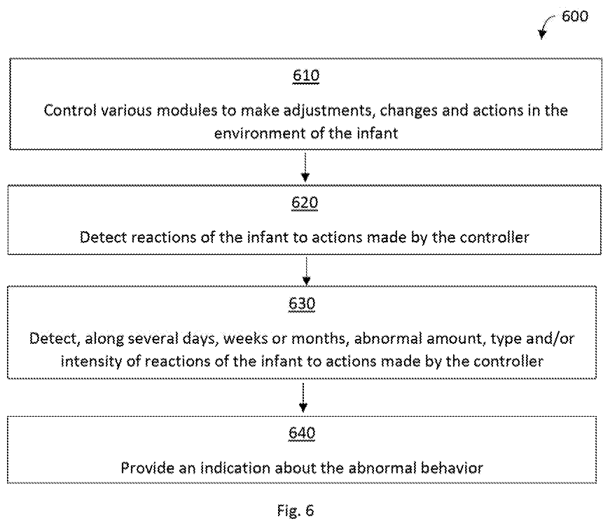

Reference is now made to FIG. 6, which is a schematic illustration of a method 600 for detection of abnormal infant development, according to some embodiments of the present disclosure, As indicated in block 610, controller 11 may control various modules to make sounds, activate toys, display patterns and/or images and/or making other adjustments, changes and actions in the environment of infant 80. Image sensor 16 and/or sound sensor 17 may capture image and/or sound datasets of infant 80 in scene 90. As indicated in block 620, based on the image and/or sound datasets, module 10 may detect reactions of infant 80 to actions made by controller 11. As indicated in block 630, decision module 10 may detect, for example along several hours, days, weeks or months, abnormal amount, type and/or intensity of reactions of infant 80 to actions made by controller 11. As indicated in block 640, decision module 10 and/or processor 16 may provide an indication about the abnormal behavior as output 30 and/or by indicator 26. For example, decision module 10 may be configured to detect whether the infant's hearing ability to recognize faces, motoric ability and/or any other suitable behavior is in order and/or develop according to known statistics. For example, decision module 10 may be trained according to known infant development statistics and/or according to accumulated data, to recognize normal reactions and/or development of an infant, in some embodiments, decision module 10 may detect normal/abnormal reactions and/or development according to the infant's age and/or stage of development. For example, at a certain age of the infant, decision module 10 may check whether the infant has normal reaction to non-familiar people, for example a reaction of fear and/or discontent.

Some embodiments of the present disclosure may include a system, a method, and/or a computer program product. The computer program product may include a tangible non-transitory computer readable storage medium (or media) having computer readable program instructions thereon for causing a processor to carry out aspects of the present disclosure. Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written, in any combination of one or more programming languages, including any object oriented programming language and/or conventional procedural programming languages.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof are used herein as ordinary context of the art, such as a general purpose processor, or a portable device such as a smart phone or a tablet computer, or a micro-processor, or a RISC processor, or a DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or electronic circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry. The processor and program may constitute the same apparatus, at least partially, such as an array of electronic gates, such as FPGA or ASIC, designed to perform a programmed sequence of operations, optionally comprising or linked with a processor or other circuitry.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and:/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “having” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting, of the, disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A system for dependent monitoring and caregiving, the system comprising:
an image sensor for capturing image data of a scene in which a dependent is situated;
a controller configured to control various modules in the environment of the dependent; and
a processor configured to run a decision module configured to detect a state of the dependent based on image data and to execute code instructions for:
receiving image data from the image sensor;
analyzing the received image data by the decision module and detect a momentary state of the dependent based on the analysis;
instruct the controller to control various modules in the environment of the dependent in response to the detected state; and
generate and output a report about the dependent state.

2. The system of claim 1, wherein the processor is configured to execute instructions for detecting based on received image data when the dependent's face is absent from the captured image data.

3. The system of claim 2, wherein the processor is configured to execute instructions for detecting based on received image data a situation causing the absence of the face from the image data.

4. The system of claim 1, wherein the processor is configured to execute instructions for instructing the controller to perform actions to check or fix the detected situation of the dependent.

5. The system of claim 1, wherein the processor is configured to execute instructions for detecting whether a being is crossing bounds of a defined area in the scene.

6. The system of claim 5, wherein the processor is configured to execute instructions for detecting whether the crossing being is the dependent or an authorized being.

7. The system of claim 5, wherein the processor is configured to execute instructions for transmitting an alert in case a being entering the defined area is not authorized, or in case the dependent exits a defined area.

8. The system of claim 1, wherein the processor is configured to execute instructions for detecting whether dependent is discontent.

9. The system of claim 1, wherein the processor is configured to execute instructions for instructing the controller to perform calming actions in the dependent's environment.

10. The system of claim 1, wherein the processor is configured to execute instructions for using image data as feedback to actions of the controller, by detecting the dependents reactions to the actions.

11. The system of claim 10, wherein the processor is configured to execute instructions for instructing the controller according to the feedback.

12. The system of claim 10, wherein the processor is configured to execute instructions for detecting along time abnormal behavior or development of the dependent by analyzing image data of at least a few hours.
